(19) United States
(12) Patent Application Publication
(10) Pub. No.: US 2025/0355650 A1
(43) Pub. Date: Nov. 20, 2025

(54) Method and system for recognizing mixed languages

(71) Applicant: Guangzhou Yunbiaoju Network Technology Co., Ltd., Guangzhou City, (CN)

(72) Inventor: Yadong ZHANG, Guangzhou City (CN)

(21) Appl. No.: 19/209,792

(22) Filed: May 16, 2025

(30) Foreign Application Priority Data
May 17, 2024 (CN) 202410614947.5

(51) Int. Cl. G06F 8/41; G06F 40/279; G06F 40/47

(52) U.S. Cl. CPC G06F 8/427; G06F 40/279; G06F 40/47

(57) ABSTRACT

This application relates to the field of language compilation technology and discloses a method and system for recognizing mixed languages. The method includes: obtaining a micro-language written by a user using keywords within the user's business domain based on a preset programming language strategy; obtaining a domain-specific language corresponding to the micro-language; parsing the domain-specific language and the micro-language and obtaining a mixed abstract syntax tree based on the parsing results; and using the mixed abstract syntax tree to obtain machine code corresponding to the micro-language. By comparing the first and second abstract syntax trees and comparing with historical data, the structure of the mixed abstract syntax tree is optimized, accurate compilation from micro-language to machine code is achieved, and optimization of micro-language writing is also realized. Finally, a simple language compilation environment is provided for beginners in language compilation.

### FIELD OF INVENTION

The present application relates to the field of language compilation technology, and more specifically, to a method and system for recognizing mixed languages.

### DESCRIPTION OF RELATED ARTS

In language compilation, complex keywords and syntax can present challenges for novice programmers, thereby increasing the barrier to entry. Moreover, implementing complex business logic often results in increasingly complex program code, which can hinder comprehension and degrade the user experience.

### SUMMARY OF THE PRESENT INVENTION

It is an object of the present invention to provide a method and system for recognizing mixed languages that addresses the aforementioned problems in the prior art.

In a first aspect, the present invention provides a method for recognizing mixed languages, comprising the following steps:
S1: Acquiring a micro-language, wherein the micro-language is a program language written by a user based on a preset programming language policy using keywords belonging to the user's business domain. The user-defined domain language comprises a plurality of different types of languages (e.g., Language B and Language C);
S2: using the micro-language to obtain a domain-specific language corresponding to the micro-language;
S3: Parsing the domain-specific language and the micro-language, and obtaining a mixed abstract syntax tree based on parsing results;
S4: Performing machine code compilation using the hybrid abstract syntax tree to obtain machine code corresponding to the micro-language.

By writing a micro-language, program writing is simplified, and accurate compilation of the micro-language is achieved through the mixed abstract syntax tree.

Preferably, generating a parser B for Language B in the domain language using the micro-language parser A of ObjectSense on a first processor and generating a parser C for Language C in the domain language using the micro-language parser A of ObjectSense on a second processor. Preferably, simultaneously parsing the user-defined domain language using the micro-language parser A of ObjectSense, the parser B generated in S2, and the parser C generated in S3, to generate an Abstract Syntax Tree of the hybrid language.

Preferably, the user based on the preset programming language strategy comprises:
the user writing the micro-language based on keyword characteristics of the programming language.

By writing the micro-language based on the keyword characteristics of the programming language and keywords specific to the business domain, program writing is simplified and program readability is improved.

Preferably, parsing the domain-specific language and the micro-language comprises:
based on the domain-specific language, obtaining an abstract syntax tree of the domain-specific language, and defining the abstract syntax tree of the domain-specific language as a first abstract syntax tree;
Based on the micro-language, obtaining an abstract syntax tree of the micro-language, and defining the abstract syntax tree of the micro-language as a second abstract syntax tree.

The first and second abstract syntax trees provide logical support for machine code compilation of the micro-language.

Preferably, obtaining the mixed abstract syntax tree based on the parsing results comprises the following steps:
comparing the first abstract syntax tree and the second abstract syntax tree, retaining coincident nodes of the first abstract syntax tree and the second abstract syntax tree in the mixed abstract syntax tree, and retaining nodes in the second abstract syntax tree that do not coincide with the first abstract syntax tree in the mixed abstract syntax tree;
analyzing each node in the first abstract syntax tree that does not coincide with the second abstract syntax tree, the analyzing comprising:

Obtaining historical data corresponding to each node in the first abstract syntax tree that does not coincide with the second abstract syntax tree. Calculating a compilation accuracy rate “P” for each non-coincident node,

$${P}_{k} = \frac{{n}_{k}}{{N}_{k}} ,$$

wherein Pₖ is the compilation accuracy rate corresponding to node “k”, Nₖ is a number of times node “k” appears, and nₖ is a number of times node “k” is correctly compiled. Determining whether the compilation accuracy rate is greater than a preset compilation accuracy rate threshold, and if so, retaining node “k” in the mixed abstract syntax tree, and otherwise discarding node “k”. Preferably, by acquiring historical data corresponding to each node in the first abstract syntax tree that is not common to the second abstract syntax tree, calculating a compilation accuracy rate P for each non-common node, determining whether the compilation accuracy rate of a node k is greater than a preset compilation accuracy rate threshold (99.9%), and if yes, retaining the node k in the hybrid abstract syntax tree, otherwise discarding the node k.

Analyzing the non-coincident nodes of the first and second abstract syntax trees optimizes the structure of the mixed abstract syntax tree, ensuring accurate compilation of the micro-language.

Preferably, the analyzing further comprises:
before performing the compilation accuracy rate calculation, acquiring micro-languages in historical data corresponding to each node in the first abstract syntax tree that is not common to the second abstract syntax tree, and defining the micro-languages in the historical data corresponding to each node as historical micro-languages;
Performing industry semantic analysis on the historical micro-language corresponding to the node k and the micro-language corresponding to the current compilation using NLP technology, determining whether the results of the industry semantic analysis are the same, and if yes, retaining the node k and performing the compilation accuracy rate calculation, otherwise discarding the node k.

Comparing the current compilation with historical data improves the accuracy of the mixed abstract syntax tree and facilitates continuous optimization of micro-language writing through the accumulation of historical data.

In a second aspect, the present invention provides a system for recognizing mixed languages, comprising:
a micro-language acquisition module configured to acquire a micro-language input by a user, wherein the micro-language is a programming language written by the user using keywords within the user's business domain based on a preset programming language strategy;
a micro-language conversion module configured to perform language conversion using the micro-language to obtain a domain-specific language corresponding to the micro-language;
a mixed abstract syntax tree generation module configured to parse the domain-specific language and the micro-language, and obtain a mixed abstract syntax tree based on parsing results;
A compilation module configured to perform machine code compilation using the mixed abstract syntax tree to obtain machine code corresponding to the micro-language.

The preferred embodiments and their advantages for the system are the same as described above for the method. The system works in conjunction with the method, enabling language compilers to write programs based on keywords within their business domain, reducing programming difficulty, improving program readability, and facilitating program maintenance.

The method and system of the present invention reduce programming difficulty, improve program readability, and facilitate program maintenance through the use of micro-languages. By comparing the first and second abstract syntax trees and using historical data, the structure of the mixed abstract syntax tree is optimized, achieving accurate compilation from micro-language to machine code and enabling optimization of micro-language writing.

### BRIEF DESCRIPTION OF THE DRAWINGS

For a more complete understanding of the present invention, reference is now made to the following drawings, which are for illustrative purposes only and are not intended to limit the scope of the invention.

FIG. 1 is a schematic flow chart illustrating a method for recognizing mixed languages according to an embodiment of the present invention.

FIG. 2 is a specific example provided in an embodiment of the present application.

FIG. 3 is a schematic block diagram illustrating a system for recognizing mixed languages according to an embodiment of the present invention.

### DETAILED DESCRIPTION OF THE PREFERRED EMBODIMENT

The following detailed description sets forth numerous specific details to provide a thorough understanding of the invention. However, it will be apparent to one of ordinary skill in the art that the invention may be practiced without these specific details. In other instances, well-known features have not been described in detail to avoid unnecessarily obscuring the invention.

Throughout this specification, the term “comprising” means that the recited elements are necessarily included, but that other elements may be optionally included as well.

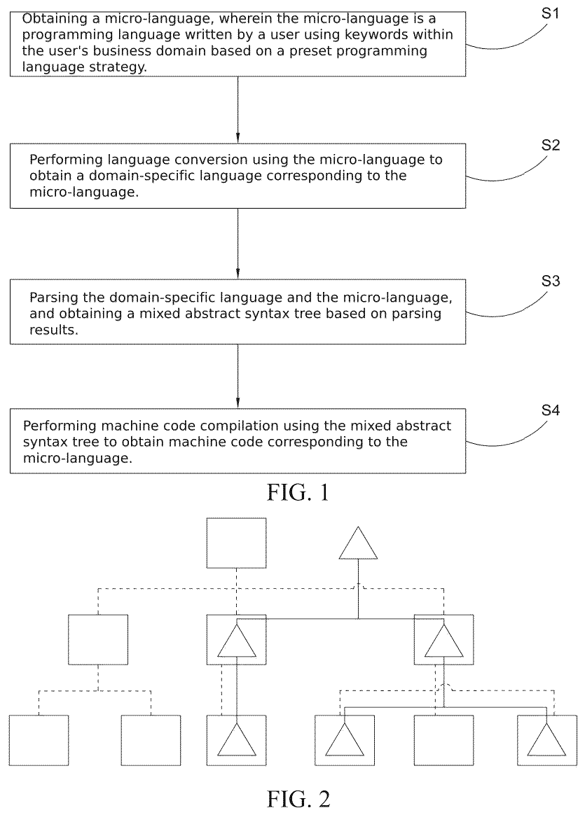

Referring now to FIG. 1, a first aspect of this embodiment discloses a method for recognizing mixed languages, comprising the following steps:

Obtaining a micro-language (S1): The micro-language is a programming language written by a user using keywords within the user's business domain based on a preset programming language strategy. This strategy defines the rules and conventions for constructing the micro-language, ensuring consistency and enabling automatic processing. The micro-language is designed to simplify programming by using familiar business terms. The user-defined domain language comprises a plurality of different types of languages (e.g., Language B and Language C).

Performing language conversion (S2): The micro-language is converted to obtain a corresponding domain-specific language (DSL). This conversion translates the user-friendly micro-language into a more structured and formally defined language suitable for parsing and compilation.

Parsing (S3): The domain-specific language and the micro-language are parsed, and a mixed abstract syntax tree (AST) is obtained based on the parsing results. This mixed AST represents the combined structure of both languages, capturing the relationships between the micro-language elements and their corresponding DSL constructs.

Machine code compilation (S4): Machine code corresponding to the micro-language is obtained using the mixed AST. The compiler traverses the mixed AST, generating the appropriate machine instructions for execution. Preferably, generating a parser B for Language B in the domain language using the micro-language parser A of ObjectSense on a first processor and generating a parser C for Language C in the domain language using the micro-language parser A of ObjectSense on a second processor. Preferably, simultaneously parsing the user-defined domain language using the micro-language parser A of ObjectSense, the parser B generated in S2, and the parser C generated in S3, to generate an Abstract Syntax Tree of the hybrid language.

By writing a micro-language, program writing is simplified, and accurate compilation of the micro-language is achieved using the mixed abstract syntax tree.

Specifically, the user basing on the preset programming language policy specifically comprises:
The user writing the micro-language based on keyword characteristics of the programming language.

Further, by writing the micro-language based on the keyword characteristics of the programming language and keywords of the business domain, the writing of programs is simplified, and the readability of programs is improved. It is worth noting that the execution of the two steps of generating the parser B for Language B in the domain language using the micro-language parser A of ObjectSense and generating the parser C for Language C in the domain language using the micro-language parser A of ObjectSense will call a large number of the same functions and data. When the two steps are executed on the same processor, it is very easy to cause race conditions and mutual exclusion, resulting in a significant reduction in the processor's running speed and the occurrence of errors. Therefore, the two steps of generating the parser B for Language B in the domain language using the micro-language parser A of ObjectSense and generating the parser C for Language C in the domain language using the micro-language parser A of ObjectSense need to be run on two different processors, the first processor and the second processor, to avoid running the above two steps on a single processor and to avoid the occurrence of race conditions or mutual exclusion when the processor is running.

It should be noted that the micro-language aims to facilitate the implementation of business function logic for users, allowing users to customize and extend keywords. For example, based on Codigger system, in the writing of ObjectSense micro-language, the writing must conform to the keyword characteristics of ObjectSense. The micro-language, being related to business functions, makes the code program logic concise and easy to maintain, and facilitates users to implement function logic within their specific business scope. ObjectSense programming language has concise and clear keywords and syntax, which is user-friendly for beginners and reduces the entry threshold.

In implementing different business functions, complex functional logic can cause the written program code to become complex. To maintain clarity and ease of use for programs written in OSE language, the micro-language is defined.

Specifically, parsing the domain-specific language and the micro-language specifically comprises:
generating an abstract syntax tree of the domain-specific language based on the domain-specific language, wherein the domain-specific language abstract tree is defined as a first abstract syntax tree;
Generating an abstract syntax tree of the micro-language based on the micro-language, wherein the abstract syntax tree of the micro-language is defined as a second abstract syntax tree.

The first abstract syntax tree and the second abstract syntax tree provide logical support for the machine code compilation of the micro-language.

Specifically, with reference to FIG. 2, deriving the hybrid abstract syntax tree based on the parsing results specifically comprises:
in FIG. 2, triangles represent nodes of the first abstract syntax tree, and rectangles represent nodes of the second abstract syntax tree; nodes represented by only a triangle or a rectangle indicate non-overlapping nodes, while nodes represented by both a triangle and a rectangle indicate overlapping nodes;
comparing the first abstract syntax tree and the second abstract syntax tree, retaining nodes that are common to both the first abstract syntax tree and the second abstract syntax tree in the hybrid language abstract tree, and retaining nodes in the second abstract syntax tree that are not common to the first abstract syntax tree in the hybrid language abstract tree;
analyzing each node in the first abstract syntax tree that is not common to the second abstract syntax tree, wherein the analysis steps comprise:
Obtaining historical data corresponding to each node in the first abstract syntax tree that does not coincide with the second abstract syntax tree. Calculating a compilation accuracy rate “P” for each non-coincident node,

$${P}_{k} = \frac{{n}_{k}}{{N}_{k}} ,$$

wherein Pₖ is the compilation accuracy rate corresponding to node “k”, Nₖ is a number of times node “k” appears, and nₖ is a number of times node “k” is correctly compiled. Determining whether the compilation accuracy rate is greater than a preset compilation accuracy rate threshold, and if so, retaining node “k” in the mixed abstract syntax tree, otherwise discarding node “k”. Preferably, by acquiring historical data corresponding to each node in the first abstract syntax tree that is not common to the second abstract syntax tree, calculating a compilation accuracy rate P for each non-common node, determining whether the compilation accuracy rate of a node k is greater than a preset compilation accuracy rate threshold (99.9%), and if yes, retaining the node k in the hybrid abstract syntax tree, otherwise discarding the node k. It can be understood that setting the preset compilation accuracy rate threshold to 99.9% is to avoid misjudgment of the compilation accuracy rate of the node k caused by compilation errors of the hybrid language itself leading to the parsers B and C being unable to correctly parse and generate incorrect machine code, while ensuring compilation correctness as much as possible.

Through the analysis of the nodes in the first abstract syntax tree that are not common to the second abstract syntax tree, the structure of the hybrid abstract syntax tree is optimized, ensuring the accurate compilation of the micro-language.

The analyzing further comprises:
Before performing the compilation accuracy rate calculation, obtaining historical micro-languages from historical data corresponding to each node in the first abstract syntax tree that does not coincide with the second abstract syntax tree, and defining the obtained micro-languages as historical micro-languages.

Using NLP technology to perform industry meaning analysis on the historical micro-language corresponding to node “k” and the micro-language corresponding to the current compilation, and determining whether the results of the industry meaning analysis are the same. If so, retaining node “k” and performing the compilation accuracy rate calculation; otherwise, discarding node “k”.

Further, by comparing the current compilation with historical data, the accuracy of the hybrid abstract syntax tree is improved, and the writing of the micro-language is continuously optimized through the accumulation of historical data. It should be noted that the abstract syntax tree parsed from the program is a hybrid of the abstract syntax tree of the micro-language and the abstract syntax tree of the domain-specific language, which distinguishes it from the macro language definition of other languages, where the macro language of other languages constitutes the abstract syntax tree of those other languages.

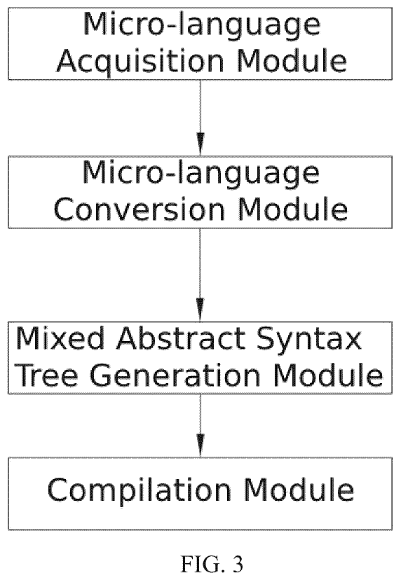

Referring now to FIG. 3, a second aspect of this embodiment discloses a system for recognizing mixed languages, comprising:

A micro-language acquisition module configured to acquire a micro-language input by a user, wherein the micro-language is a programming language written by the user using keywords within the user's business domain based on a preset programming language strategy.

A micro-language conversion module configured to perform language conversion using the micro-language to obtain a domain-specific language corresponding to the micro-language.

A mixed abstract syntax tree generation module configured to parse the domain-specific language and the micro-language, and obtain a mixed abstract syntax tree based on parsing results.

A compilation module configured to perform machine code compilation using the mixed abstract syntax tree to obtain machine code corresponding to the micro-language.

In summary, the method and system for recognizing mixed languages reduce the difficulty of programming, improve program readability, and facilitate program maintenance by using micro-language writing. By comparing the first abstract syntax tree and the second abstract syntax tree and comparing with historical data, the structure of the mixed abstract syntax tree is optimized, thereby realizing accurate compilation from micro-language to machine code and also realizing optimization of micro-language writing.

It will be understood that the embodiments described herein may be implemented in hardware, software, firmware, middleware, code, or any suitable combination thereof. For a hardware implementation, a processing unit may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof.

For a software implementation, some or all of the processes described in the embodiments may be implemented by a computer program product including instructions that, when executed by related hardware, cause the hardware to perform the described processes. Such a program may be stored or transmitted as one or more instructions or code on a computer-readable storage medium. Computer-readable storage media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. The computer-readable storage medium is preferably a non-transitory storage medium.

It is to be understood that the foregoing descriptions are merely illustrative of preferred embodiments of the present invention, and are not intended to be limiting. Many modifications and variations may be made by those skilled in the art without departing from the spirit and scope of the invention. Any modification, equivalent substitution, or improvement within the spirit and principle of the present invention is intended to be included within the scope of protection of the present invention.

What is claimed is:

1. A method for recognizing mixed languages, the method comprising:
S1: obtaining a micro-language, wherein the micro-language is a programming language written by a user using keywords within a user's business domain based on a preset programming language strategy;
S2: performing language conversion using the micro-language to obtain a domain-specific language corresponding to the micro-language;
S3: parsing the domain-specific language and the micro-language, and obtaining a mixed abstract syntax tree based on parsing results;
S4: performing machine code compilation using the mixed abstract syntax tree to obtain machine code corresponding to the micro-language; wherein the step of parsing of the domain-specific language and the micro-language specifically comprises the following steps:
generating an abstract syntax tree of the domain-specific language based on the domain-specific language, wherein the domain-specific language abstract tree is defined as a first abstract syntax tree;
generating an abstract syntax tree of the micro-language based on the micro-language, wherein the micro-language abstract tree is defined as a second abstract syntax tree, wherein the generating of the hybrid abstract syntax tree based on the parsing results specifically comprises the following steps:
comparing the first abstract syntax tree and the second abstract syntax tree, retaining nodes that are common to both the first abstract syntax tree and the second abstract syntax tree in the hybrid language abstract tree, and also retaining nodes in the second abstract syntax tree that are not common to the first abstract syntax tree in the hybrid language abstract tree;
analyzing each node in the first abstract syntax tree that does not coincide with the second abstract syntax tree, the analyzing comprising:
acquiring historical data corresponding to each node in the first abstract syntax tree that does not coincide with the second abstract syntax tree. Calculating a compilation accuracy rate “P” for each non-coincident node,
$${P}_{k} = \frac{{n}_{k}}{{N}_{k}} ,$$
wherein Pₖ is the compilation accuracy rate corresponding to node “k”, Nₖ is a number of times node “k” appears, and nₖ is a number of times node “k” is correctly compiled. Determining whether the compilation accuracy rate is greater than a preset compilation accuracy rate threshold, and if so, retaining node “k” in the mixed abstract syntax tree, otherwise discarding node “k”.

2. The method for identifying a hybrid language according to claim 1, characterized in that the user basing on the preset programming language policy specifically comprises:
the user writing the micro-language based on keyword characteristics of the programming language.

3. The method for identifying a hybrid language according to claim 1, characterized in that the analysis steps further comprises the following steps: before performing the compilation accuracy rate calculation, obtaining historical micro-languages from historical data corresponding to each node in the first abstract syntax tree that does not coincide with the second abstract syntax tree, and defining the obtained micro-languages as historical micro-languages;
using NLP technology to perform industry meaning analysis on a historical micro-language corresponding to node “k” and the micro-language corresponding to current compilation, and determining whether results of the industry meaning analysis are the same, and if so, retaining node “k” and performing the compilation accuracy rate calculation, otherwise discarding node “k”.

4. A system for recognizing mixed languages, the system comprising:
A micro-language acquisition module configured to acquire a micro-language input by a user, wherein the micro-language is a programming language written by the user using keywords within the user's business domain based on a preset programming language strategy;
A micro-language conversion module configured to perform language conversion using the micro-language to obtain a domain-specific language corresponding to the micro-language;
A mixed abstract syntax tree generation module configured to parse the domain-specific language and the micro-language, and obtain a mixed abstract syntax tree based on parsing results;
A compilation module configured to perform machine code compilation using the mixed abstract syntax tree to obtain machine code corresponding to the micro-language, wherein the step of parsing of the domain-specific language and the micro-language specifically comprises the following steps:
generating an abstract syntax tree of the domain-specific language based on the domain-specific language, wherein the domain-specific language abstract tree is defined as a first abstract syntax tree;
generating an abstract syntax tree of the micro-language based on the micro-language, wherein the micro-language abstract tree is defined as a second abstract syntax tree, wherein the step of generating of the hybrid abstract syntax tree based on the parsing results specifically comprises:
comparing the first abstract syntax tree and the second abstract syntax tree, retaining nodes that are common to both the first abstract syntax tree and the second abstract syntax tree in the hybrid language abstract tree, and also retaining nodes in the second abstract syntax tree that are not common to the first abstract syntax tree in the hybrid language abstract tree;
analyzing each node in the first abstract syntax tree that does not coincide with the second abstract syntax tree, the step of analyzing comprising the following step:
acquirng historical data corresponding to each node in the first abstract syntax tree that does not coincide with the second abstract syntax tree. Calculating a compilation accuracy rate “P” for each non-coincident node,
$${P}_{k} = \frac{{n}_{k}}{{N}_{k}} ,$$
wherein Pₖ is the compilation accuracy rate corresponding to node “k”, Nₖ is a number of times node “k” appears, and nₖ is a number of times node “k” is correctly compiled. Determining whether the compilation accuracy rate is greater than a preset compilation accuracy rate threshold, and if so, retaining node “k” in the mixed abstract syntax tree, otherwise discarding node “k”.

5. The system of claim 4, wherein the analyzing further comprises the following steps: before performing the compilation accuracy rate calculation, obtaining historical micro-languages from historical data corresponding to each node in the first abstract syntax tree that does not coincide with the second abstract syntax tree, and defining the obtained micro-languages as historical micro-languages;
using NLP technology to perform industry meaning analysis on a historical micro-language corresponding to node “k” and the micro-language corresponding to current compilation, and determining whether results of the industry meaning analysis are the same, and if so, retaining node “k” and performing the compilation accuracy rate calculation, otherwise discarding node “k”.
